(19) United States
(12) Patent Application Publication
(10) Pub. No.: US 2016/0231706 A1
(43) Pub. Date: Aug. 11, 2016

(54) SYSTEM AND METHOD FOR GENERATING OCCLUSION-CULLED HOLOGRAM AT HIGH SPEED USING OMNIDIRECTIONAL ANGULAR SPECTRUM

(71) Applicant: ELECTRONICS AND TELECOMMUNICATIONS RESEARCH INSTITUTE, Daejeon (KR)

(72) Inventor: Seung Taik OH, Seoul (KR)

(21) Appl. No.: 14/997,493

(22) Filed: Jan. 16, 2016

(30) Foreign Application Priority Data
Feb. 10, 2015 (KR) 10-2015-0020258

(51) Int. Cl. G03H 1/08; G03H 1/16

(52) U.S. Cl. CPC G03H 1/0808; G03H 1/0891; G03H 1/16; G03H 2001/0816

(57) ABSTRACT

A system and method for generating an occlusion-culled hologram at a high speed using an omnidirectional angular spectrum in which it is possible to uniformly maintain a hologram generation speed regardless of the sampling number of an object and increase the three-dimensional (3D) effect of a hologram image. The system includes a omnidirectional angular spectrum generation module configured to receive geometric information of an object and generate an occlusion-culled omnidirectional angular spectrum based on the received geometric information, and a hologram generation module configured to generate a hologram based on the omnidirectional angular spectrum provided from the omnidirectional angular spectrum generation module and the positional information and the directional information of a hologram provided from the outside.

### CROSS-REFERENCE TO RELATED APPLICATION

This application claims priority to and the benefit of Korean Patent Application No. 2015-0020258, filed on Feb. 10, 2015, the disclosure of which is incorporated herein by reference in its entirety.

### BACKGROUND

1. Field of the Invention

The present invention relates to a system and method for generating an occlusion-culled hologram at a high speed using an omnidirectional angular spectrum, and more particularly, to a system and method for generating a hologram in which it is possible to uniformly maintain a hologram generation speed regardless of the sampling number of an object and increase the three-dimensional (3D) effect of a hologram image.

2. Discussion of Related Art

Hologram technology is a 3D image technology that provides an observer with a natural 3D effect.

Analog holography in which an interference pattern between an object wave and a reference wave generated when applying laser beams is recorded in a film to reproduce a 3D image has been used.

However, with the development of digital technology, digital holography technology for digitally photographing or calculating an interference pattern and reproducing a hologram image using a digital display device is recently under active research. In particular, a digital hologram generated based on numerical computations of light waves generated from an object is referred to as a computer generated hologram (CGH).

A CGH has advantages in that it is possible to generate a hologram of a virtual model used in computer graphics, etc. as well as a hologram of an actual thing, and an interaction with a video hologram is possible.

Unless mentioned otherwise below, a “hologram” is a CGH.

A hologram requires a large amount of computation because one point of an object influences all points of the hologram. Therefore, a method of increasing a hologram generation speed has been actively researched.

A typical fast hologram generation method is a look-up table (LUT)-based fast generation method.

The LUT-based fast generation method was proposed by Mark Lucente in 1993 for the first time. Basically, computation of an object wave is done based on a relative position between an object and a hologram point. Also, a repeatedly used routine which requires a large amount of computation is computed and tabulated in a memory in advance, so that the corresponding portion of the table is read without calculation as necessity to increase a computation speed.

Using the LUT-based method, it is possible to remarkably reduce a hologram generation time. However, as the sampling number of an object increases, an increase in computation time is unavoidable. This means that the LUT-based method is not appropriate for fast generation of a high-quality hologram.

Meanwhile, occlusion culling is an important process to increase a 3D effect, but if an occlusion culling method is applied is for the LUT-based method, then the computation time of the LUT-based method becomes much longer since ray-object interaction computation which is a core process of occlusion culling is very expensive operation.

A general hologram is in a two-dimensional (2D) planar shape. Such a planar hologram provides viewpoints within only a predetermined angle, and it is not possible to observe an object in all directions. For omnidirectional observation, it is possible to use a spherical hologram obtained by recording object waves at a spherical surface.

A spherical hologram has an advantage in that it is possible to observe an object in all directions, but has a disadvantage of slow computation speed because it is not possible to use Fourier transform in a computation process. Also, a method of generating a spherical hologram by continuously attaching plane surfaces along a spherical surface and thereby improving computation efficiency has been proposed, but is not appropriate for fast generation.

### SUMMARY OF THE INVENTION

The present invention is directed to providing a system and method for generating a hologram in which it is possible to uniformly maintain a hologram generation speed regardless of the sampling number of an object.

The present invention is also directed to providing a system and method for generating a hologram in which it is possible to increase the three-dimensional (3D) effect of a hologram image.

According to an aspect of the present invention, there is provided a system for generating an occlusion-culled hologram at a high speed using an omnidirectional angular spectrum, the system including: an omnidirectional angular spectrum generation module configured to receive geometric information of an object and generate an occlusion-culled omnidirectional angular spectrum based on the received geometric information; and a hologram generation module configured to generate a hologram based on the omnidirectional angular spectrum provided from the omnidirectional angular spectrum generation module and positional information and directional information of a hologram provided from an outside.

The omnidirectional angular spectrum generation module may determine whether or not all frequency vectors in a neighboring frequency vector set extracted based on sampling information included in the geometric information intersect an object mesh, calculate Fourier coefficients for frequency vectors not intersecting the object mesh to accumulate the calculated Fourier coefficients, and generate an accumulation result as the occlusion-culled omnidirectional angular spectrum.

When a plurality of pieces of geometric information are received, the omnidirectional angular spectrum generation module may determine whether or not all frequency vectors in respective neighboring frequency vector sets extracted based on respective pieces of sampling information included in the plurality of pieces of geometric information intersect the object mesh.

The omnidirectional angular spectrum generation module may store the generated omnidirectional angular spectrum in a discrete structure of a spherical surface.

The hologram generation module may convert the omnidirectional angular spectrum into a planar angular spectrum on an xy-plane by rotating the omnidirectional angular spectrum based on the positional information and the directional information of the hologram, propagate the converted planar angular spectrum by a distance between the hologram and the object, and then generate the hologram by performing a Fourier transform on the propagated planar angular spectrum.

The hologram generation module may convert the omnidirectional angular spectrum by applying a surface element ratio to the planar angular spectrum.

According to another aspect of the present invention, there is provided a method of generating an occlusion-culled hologram at a high speed using an omnidirectional angular spectrum, the method including: receiving geometric information of an object, and generating an occlusion-culled omnidirectional angular spectrum based on the received geometric information; and generating a hologram based on the generated omnidirectional angular spectrum and positional information and directional information of a hologram provided from an outside.

The generating of the omnidirectional angular spectrum may include: extracting a neighboring frequency vector set based on sampling information included in the received geometric information of the object; determining whether or not a frequency vector in the extracted neighboring frequency vector set intersect an object mesh; when it is determined that the frequency vector does not intersect the object mesh, calculating and accumulating a Fourier coefficient for the determined frequency vector; and when it is determined that the frequency vector intersects the object mesh, determining whether there is another frequency vector in the neighboring frequency vector set.

The calculating and accumulating of the Fourier coefficient for the determined frequency vector may include, after accumulating the Fourier coefficient, determining whether there is another frequency vector in the neighboring frequency vector set.

The determining of whether there is another frequency vector in the neighboring frequency vector set may include determining, when there is another frequency vector, whether the other frequency vector intersects the object mesh, and determining, when there is no another frequency vector, whether there is next sampling information.

The determining of whether there is another frequency vector in the neighboring frequency vector set may further include, extracting the neighboring frequency vector set when it is determined that there is next sampling information, and acquiring omnidirectional angular spectrum data when it is determined that there is no next sampling information.

The generating of the hologram may include: converting the omnidirectional angular spectrum on a spherical surface into a planar angular spectrum on an x-y plane by rotating the planar angular spectrum based on the positional information and the directional information of the hologram; propagating the converted omnidirectional angular spectrum by a distance between the hologram and the object; and generating the hologram by performing a Fourier transform on the propagated planar angular spectrum.

The converting of the omnidirectional angular spectrum on the spherical surface into the planar angular spectrum on the x-y plane may include converting a coordinate system basis vector of the hologram into a base coordinate system basis vector of a spherical mesh.

The converting of the omnidirectional angular spectrum on the spherical surface into the planar angular spectrum on the x-y plane may include converting the omnidirectional angular spectrum by applying a surface element ratio to the planar angular spectrum.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a block diagram showing a configuration of a system for generating an occlusion-culled hologram at a high speed using an omnidirectional angular spectrum according to an exemplary embodiment of the present invention;

FIG. 2 is a flowchart illustrating a process of generating an omnidirectional angular spectrum by an omnidirectional angular spectrum generation module according to an exemplary embodiment of the present invention;

FIG. 3 is a diagram showing an example of a discrete structure of a spherical surface for defining an omnidirectional angular spectrum;

FIG. 4 is a flowchart illustrating a process of generating a hologram by a hologram generation module according to an exemplary embodiment of the present invention;

FIG. 5 is a diagram showing an example of a coordinate transform when an omnidirectional angular spectrum is rotated;

FIG. 6 is a diagram showing states of angular spectra before and after a conversion; and

FIG. 7 is a diagram showing an example of a hologram interaction system using a system for generating an occlusion-culled hologram at a high speed using an omnidirectional angular spectrum according to an exemplary embodiment of the present invention.

### DETAILED DESCRIPTION OF EXEMPLARY EMBODIMENTS

Advantages and features of the present invention and a method of achieving the same will be more clearly understood from embodiments described below in detail with reference to the accompanying drawings. However, the present invention is not limited to the following embodiments and may be implemented in various different forms. The embodiments are provided merely for complete disclosure of the present invention and to fully convey the scope of the invention to those of ordinary skill in the art to which the present invention pertains. The present invention is defined only by the scope of the claims. Throughout the specification, like reference numerals refer to like elements.

In describing the present invention, any detailed description of related art of the invention will be omitted if it is deemed that such a description will obscure the gist of the invention unintentionally. In addition, terms used below are defined in consideration of functions in the present invention, which may be changed according to the intention of a user or an operator, or a practice, etc, Therefore, the definitions of these terms should be made based on the overall description of this specification.

Hereinafter, a system and method for generating an occlusion-culled hologram at a high speed using an omnidirectional angular spectrum according to exemplary embodiments of the present invention will be described in detail with reference to the accompanying drawings.

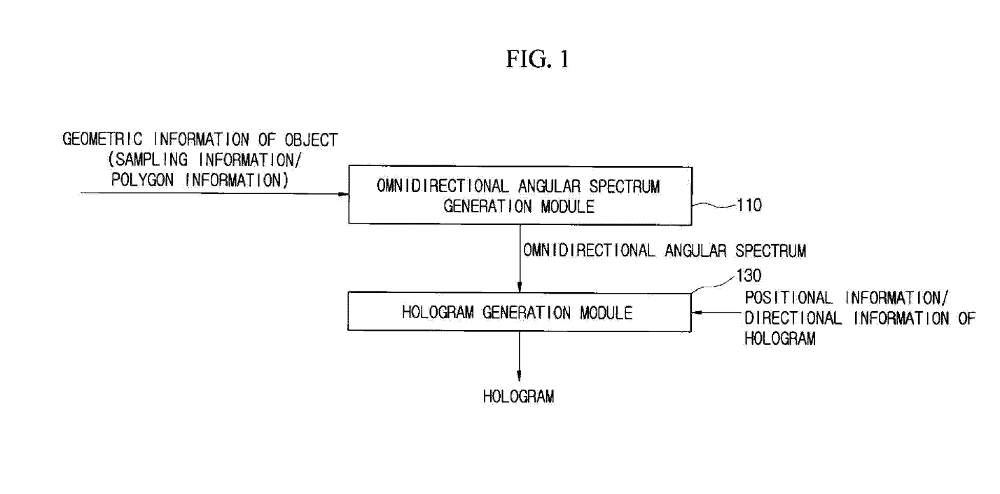

FIG. 1 is a block diagram showing a configuration of a system for generating an occlusion-culled hologram at a high speed using an omnidirectional angular spectrum according to an exemplary embodiment of the present invention.

Referring to FIG. 1, a system for generating a hologram according to an exemplary embodiment of the present invention includes an omnidirectional angular spectrum generation module 110 and a hologram generation module 130.

The omnidirectional angular spectrum generation module 110 receives geometric information of an object, generates an omnidirectional angular spectrum, and provides the generated omnidirectional angular spectrum to the hologram generation module 130.

The hologram generation module 130 generates a hologram according to the omnidirectional angular spectrum provided from the omnidirectional angular spectrum generation module 110 and the position and the direction of the hologram.

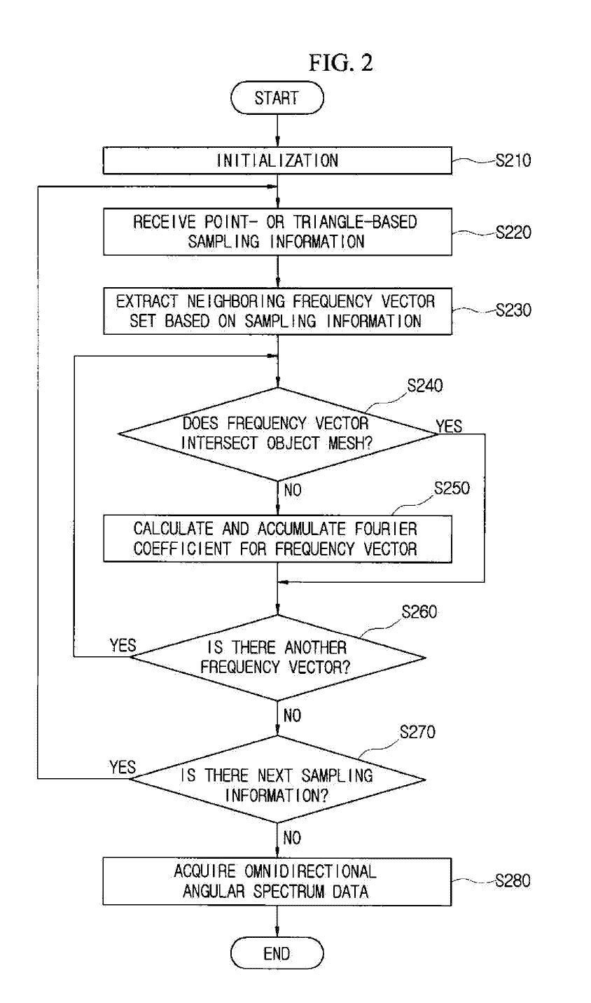

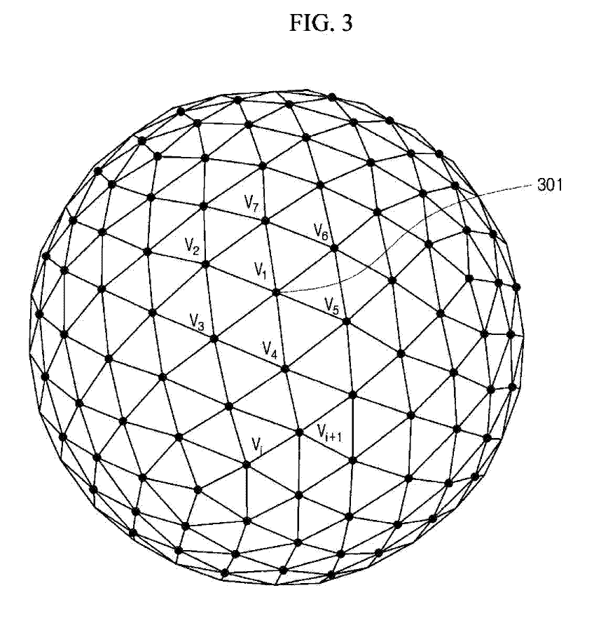

FIG. 2 is a flowchart illustrating a process of generating an omnidirectional angular spectrum by an omnidirectional angular spectrum generation module according to an exemplary embodiment of the present invention, and FIG. 3 is a diagram showing an example of a discrete structure of a spherical surface for defining an omnidirectional angular spectrum.

Referring to FIG. 2, the angular spectrum generation module 110 receives geometric information of an object and generates an omnidirectional angular spectrum of object waves. Here, the geometric information of the object includes point- or triangle-based sampling information and a polygon mesh for calculating an intersection point.

Before generation of a current omnidirectional angular spectrum, omnidirectional angular spectrum data may be initialized (S210).

Subsequently, when sampling information is input to the omnidirectional angular spectrum generation module 110 (S220), the omnidirectional angular spectrum generation module 110 extracts a neighboring frequency vector set based on the sampling information (S230). Here, the neighboring frequency vector set is a set of frequency vectors making angles equal to or smaller than a diffraction angle of a desired hologram with the normal of a current object sampling. Here, the frequency vectors can be represented by the vertices of a k-sphere mesh.

Next, the omnidirectional angular spectrum generation module 110 determines whether one random frequency vector in the neighboring frequency vector set extracted in operation S230 intersects the object mesh (S240).

When it is determined that the random frequency vector does not intersect the object mesh, the omnidirectional angular spectrum generation module 110 calculates and accumulates a Fourier coefficient for the frequency vector (S250), and determines whether there is the next frequency vector (S260).

On the other hand, when it is determined in operation S240 that the random frequency vector intersects the object mesh, the omnidirectional angular spectrum generation module 110 determines whether there is another frequency vector (S260).

When it is determined that there is another frequency vector, the process of the omnidirectional angular spectrum generation module 110 proceeds to operation S240.

All frequency vectors in the neighboring frequency vector set extracted in operation S230 are subjected to operations S240, S250, and S260, and this routine is applied to all the frequency vectors in the neighboring frequency vector set extracted in operation S230 and then finished.

Meanwhile, when it is determined in operation S260 that there is no other frequency vector, the omnidirectional angular spectrum generation module 110 determines whether there is next object sampling (S270).

When it is determined that there is next object sampling, the omnidirectional angular spectrum generation module 110 performs operations S220 to S270 in sequence. This routine is performed applied to all input object samplings and then finished.

Meanwhile, when it is determined in operation S270 that there is no next object sampling, the omnidirectional angular spectrum generation module 110 finishes the omnidirectional angular spectrum generation operation.

When the omnidirectional angular spectrum generation operation is finished according to operations S210 to S270 described above, the omnidirectional angular spectrum generation module 110 acquires omnidirectional angular spectrum data (S280).

A process of calculating a Fourier coefficient for a frequency vector performed in operation S250 will be described in further detail below.

In principle, point and triangular sampling methods require different calculation methods, and exemplary embodiments of the present invention propose an efficient point calculation method. To this end, it is assumed that there is a spherical wave emitted from one point X₀ in space.

According to the Fourier theory, it is possible to express all waves based on plane waves, and due to the characteristic of symmetry, a spherical wave has a spatial distribution expressed by Equation 1 below.

$$\begin{matrix}U ( x ) = Σexp ( j 2 π {k}_{i} \cdot ( x - {x}_{0} ) ) \\ = Σ {A}_{i} exp ( j 2 π {k}_{i} \cdot x )\end{matrix} \qquad [ Equation 1 ]$$

Here, Kᵢ is a wave vector, and Aᵢ=exp(−j2πkᵢ·x₀). Therefore, in this case, a desired Fourier coefficient is Aᵢ.

Calculation according to the triangular sampling method may be done by an analytic expression of a triangular Fourier transform.

Meanwhile, the omnidirectional angular spectrum generated by the omnidirectional angular spectrum generation module 210 is stored as the discrete structure of a spherical surface as shown in FIG. 3. Here, the radius of the sphere is required to be the inverse number of a light wavelength used for hologram generation. The sphere is referred to as k-sphere. Discretization of the k-sphere may result in a mesh structure by sequentially discretizing a regular icosahedron, and the mesh structure is referred to as k-sphere mesh.

A vertex 301 of the k-spherical mesh shown in FIG. 3 corresponds to a spatial frequency vector, and a spectrum is defined at each vertex of the k-sphere mesh.

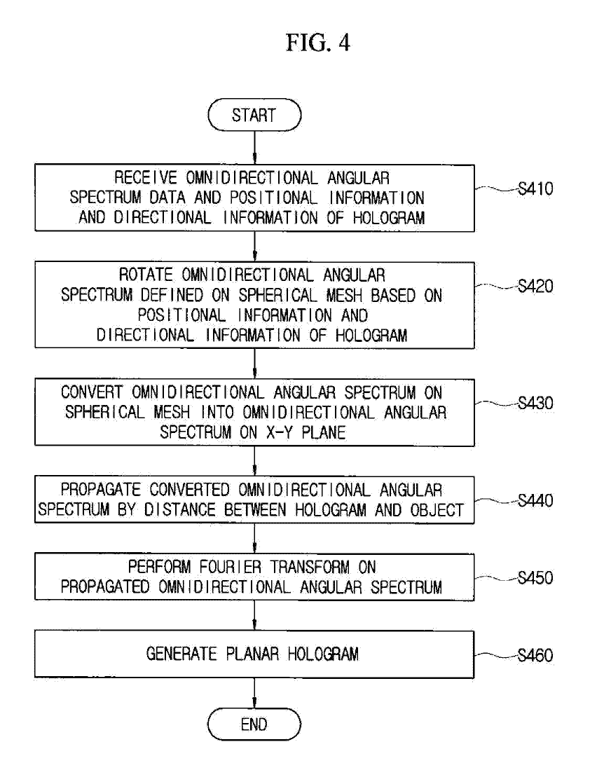

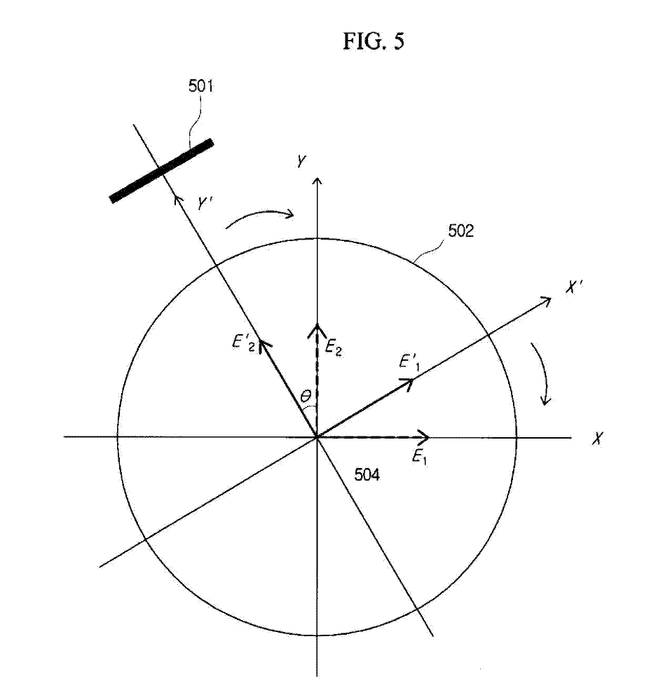

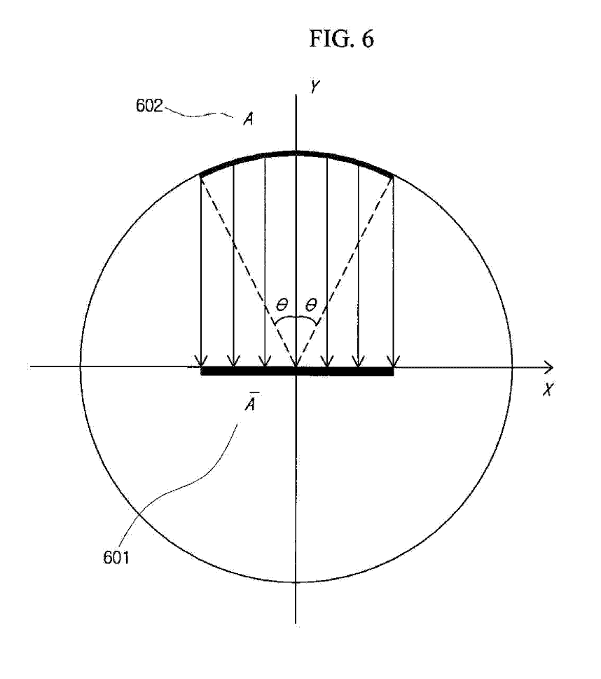

FIG. 4 is a flowchart illustrating a process of generating a hologram by a hologram generation module according to an exemplary embodiment of the present invention. FIG. 5 is a diagram showing an example of a coordinate transform when an omnidirectional angular spectrum is rotated, and FIG. 6 is a diagram showing states of angular spectra before and after a conversion.

Referring to FIG. 4, the hologram generation module 130 according to an exemplary embodiment of the present invention receives the omnidirectional angular spectrum data generated by the omnidirectional angular spectrum generation module 110 and the positional information and the directional information of the desired hologram, and generates the desired hologram.

First, the hologram generation module 130 receives the omnidirectional angular spectrum data and the positional information and the directional information of the hologram (S410), rotates the omnidirectional angular spectrum based on the received positional information and directional information of the hologram (S420), and converts the omnidirectional angular spectrum on the k-sphere into planar angular spectrum on an x-y plane (S430).

When the omnidirectional angular spectrum is rotated in operation S420, coordinate system basis vectors E₁′ and E₂′ of a hologram 501 are converted into base coordinate system basis vectors E₁ and E₂ of a k-sphere mesh 502 as shown in FIG. 5.

Also, the planar angular spectrum converted in operation S430 is expressed as shown in FIG. 6. Here, a planar angular spectrum Ā 601 after the conversion is calculated by applying a surface element ratio to an angular spectrum A 602 before the conversion. After the conversion, an angular spectrum defined on the plane is obtained, and an angular spectrum value in a uniform grid is necessary.

In general, a converted angular spectrum is not present at a grid point, and when the converted angular spectrum is applied to a lower left grid point of a cell corresponding to a converted position, fast calculation is possible. At this time, if vertices (frequency vectors) are dense enough on the k-sphere, it is almost possible to ignore an error.

Meanwhile, since the planar angular spectrum converted in operation S430 is defined at the center of the coordinate system, the hologram generation module 130 propagates the angular spectrum by the distance between the hologram and the object (S440).

Assuming that the distance between the hologram and the object is d, the hologram generation module 130 may propagate the angular spectrum using an angular spectrum propagation formula expressed as Equation 2 below.

A̅′(α, β)=A̅(α, β)exp(j2πd\sqrt{1/λ²−α²−β²})) [Equation 2]

Here, α and β are spatial frequencies, and λ is a light wavelength.

After propagating the angular spectrum by the distance between the hologram and the object in operation S440, in order to convert the angular spectrum into actual light waves, the hologram generation module 130 performs a Fourier transform on the angular spectrum (S450), and generates an occlusion-culled planar hologram based on the given positional information and directional information (S460).

It is very easy to perform accelerated processing, such as parallelization, on calculation of each operation performed by the hologram generation module 130. When the omnidirectional angular spectrum is calculated, it is possible to calculate the hologram in real time by inputting the positional information and the directional information of the hologram.

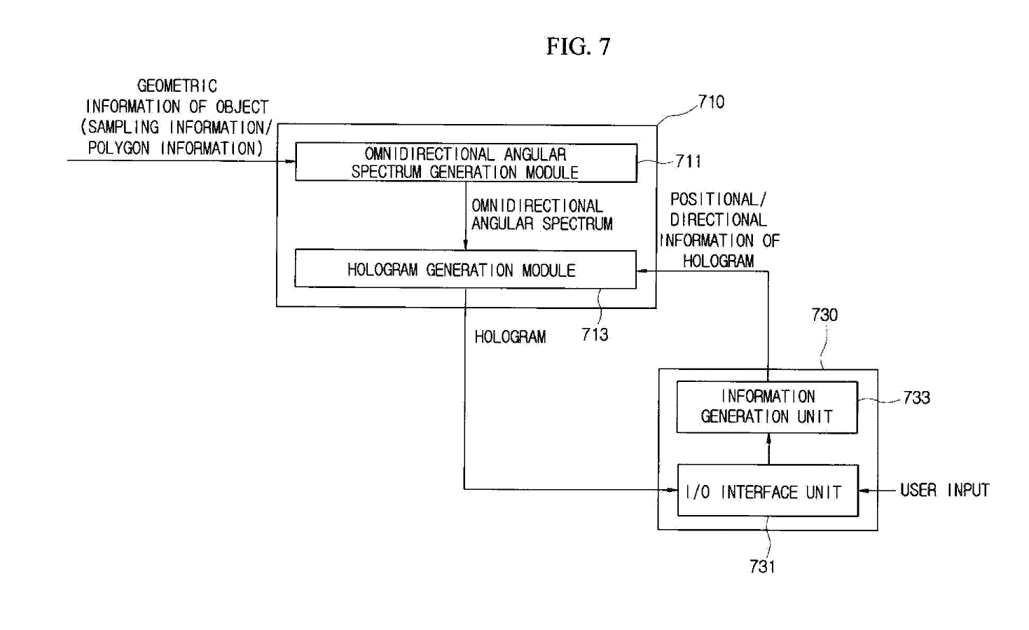

FIG. 7 is a diagram showing an example of a hologram interaction system using a system for generating a hologram according to an exemplary embodiment of the present invention.

Referring to FIG. 7, a hologram interaction system 700 may include a hologram generation unit 710 and a hologram display unit 730.

The hologram generation unit 710 receives geometric information (sampling information and a polygon mesh) of an object input from the outside of the hologram interaction system, and the positional information and the directional information of a hologram, generates an occlusion-culled planar angular spectrum based on the received geometric information of the object, and generates the hologram based on the generated omnidirectional angular spectrum and the positional information and the directional information of the hologram.

The hologram generation unit 710 may include an omnidirectional angular spectrum generation module 711 and a hologram generation module 713. The omnidirectional angular spectrum generation module 711 and the hologram generation module 713 are the same components as the omnidirectional angular spectrum generation module 110 and the hologram generation module 130 described in FIGS. 1 to 6, and detailed descriptions thereof will be omitted.

The hologram display unit 730 receives the hologram from the hologram generation unit 710, restores the hologram, and outputs a three-dimensional (3D) image. Also, the hologram display unit 730 senses a change in state information (positional information and directional information) of the object based on a user input made from the outside of the hologram interaction system, and provides the changed stated information to the hologram generation unit 710.

Therefore, changes in the position and direction of the object are provided by the hologram display unit 730 to the hologram generation unit 710, so that the hologram generation unit 710 may generate a new hologram based on the changed positional information and directional information.

Here, the hologram display unit 730 may include an input and output (I/O) interface unit 731 and an information generation unit 733.

The I/O interface unit 731 receives, restores, and outputs the hologram provided by the hologram generation unit 710 while receiving the user input.

The information generation unit 733 senses the changes in the positional information and the directional information of the object according to the user input, and generates and provides the changed positional information and directional information to the hologram generation unit 710.

According to the exemplary embodiments of the present invention, a hologram generation speed is uniformly maintained regardless of the sampling number of an object, and it is possible to rapidly generate a high-quality hologram.

Also, light waves generated from an object can be recorded in all directions using an omnidirectional angular spectrum, and a planar hologram can be generated at an arbitrary position and in an arbitrary direction by efficiently using fast Fourier transform (FFT).

Further, during generation of an omnidirectional angular spectrum, occlusion culling can be performed based on frequency vectors. Therefore, during generation of a hologram, occlusion culling is not required, and thus does not affect a hologram generation time.

Moreover, a fast hologram generation algorithm using an omnidirectional angular spectrum can be applied to the development of a system enabling an interaction between a hologram image and a user.

It will be apparent to those skilled in the art that various modifications can be made to the above-described exemplary embodiments of the present invention without departing from the spirit or scope of the invention. Thus, it is intended that the present invention covers all such modifications provided they came within the scope of the appended claims and their equivalents.

What is claimed is:

1. A system for generating an occlusion-culled hologram at a high speed using an omnidirectional angular spectrum, the system comprising:
an omnidirectional angular spectrum generation module configured to receive geometric information of an object and generate an occlusion-culled omnidirectional angular spectrum based on the received geometric information; and
a hologram generation module configured to generate a hologram based on the omnidirectional angular spectrum provided from the omnidirectional angular spectrum generation module and positional information and directional information of a hologram provided from an outside.

2. The system of claim 1, wherein the omnidirectional angular spectrum generation module determines whether or not all frequency vectors in a neighboring frequency vector set extracted based on sampling information included in the geometric information intersect an object mesh, calculates Fourier coefficients for frequency vectors not intersecting the object mesh to accumulate the calculated Fourier coefficients, and generates an accumulation result as the occlusion-culled omnidirectional angular spectrum.

3. The system of claim 2, wherein, when a plurality of pieces of geometric information are received, the omnidirectional angular spectrum generation module determines whether or not all frequency vectors in respective neighboring frequency vector sets extracted based on respective pieces of sampling information included in the plurality of pieces of geometric information intersect the object mesh.

4. The system of claim 1, wherein the omnidirectional angular spectrum generation module stores the generated omnidirectional angular spectrum in a discrete structure of a spherical surface.

5. The system of claim 1, wherein the hologram generation module converts the omnidirectional angular spectrum into a planar angular spectrum on an x-y plane by rotating the omnidirectional angular spectrum based on the positional information and the directional information of the hologram, propagates the converted planar angular spectrum by a distance between the hologram and the object, and then generates the hologram by performing a Fourier transform on the propagated planar angular spectrum.

6. The system of claim 5, wherein the hologram generation module converts the omnidirectional angular spectrum by applying a surface element ratio to the planar angular spectrum.

7. A method of generating an occlusion-culled hologram at a high speed using an omnidirectional angular spectrum, the method comprising:
receiving geometric information of an object, and generating an occlusion-culled planar angular spectrum based on the received geometric information; and
generating a hologram based on the generated omnidirectional angular spectrum and positional information and directional information of a hologram provided from an outside.

8. The method of claim 7, wherein the generating of the omnidirectional angular spectrum comprises:
extracting a neighboring frequency vector set based on sampling information included in the received geometric information of the object;
determining whether or not a frequency vector in the extracted neighboring frequency vector set intersect an object mesh;
when it is determined that the frequency vector does not intersect the object mesh, calculating and accumulating a Fourier coefficient for the determined frequency vector; and
when it is determined that the frequency vector intersects the object mesh, determining whether there is another frequency vector in the neighboring frequency vector set.

9. The method of claim 8, wherein the calculating and accumulating of the Fourier coefficient for the determined frequency vector comprises, after accumulating the Fourier coefficient, determining whether there is another frequency vector in the neighboring frequency vector set.

10. The method of claim 8, wherein the determining of whether there is another frequency vector in the neighboring frequency vector set comprises determining, when there is another frequency vector, whether the other frequency vector intersects the object mesh, and determining, when there is no another frequency vector, whether there is next sampling information.

11. The method of claim 10, wherein the determining of whether there is another frequency vector in the neighboring frequency vector set further comprises, extracting the neighboring frequency vector set when it is determined that there is next sampling information, and acquiring omnidirectional angular spectrum data when it is determined that there is no next sampling information.

12. The method of claim 7, wherein the generating of the hologram comprises:
converting the omnidirectional angular spectrum on a spherical surface into a planar angular spectrum on an x-y plane by rotating the omnidirectional angular spectrum based on the positional information and the directional information of the hologram;
propagating the converted planar angular spectrum by a distance between the hologram and the object; and
generating the hologram by performing a Fourier transform on the propagated planar angular spectrum.

13. The method of claim 12, wherein the converting of the omnidirectional angular spectrum on the spherical surface into the planar angular spectrum on the x-y plane comprises converting a coordinate system basis vector of the hologram into a base coordinate system basis vector of a spherical mesh.

14. The apparatus of claim 12, wherein the converting of the omnidirectional angular spectrum on the spherical surface into the planar angular spectrum on the x-y plane comprises converting the omnidirectional angular spectrum by applying a surface element ratio to the planar angular spectrum.
